(19) United States
(12) Patent Application Publication
(10) Pub. No.: US 2007/0006895 A1
(43) Pub. Date: Jan. 11, 2007

(54) Substrate cleaning brush, and substrate treatment apparatus and substrate treatment method using the same

(75) Inventors: Masaki Iwami, Kyoto (JP); Masanobu Sato, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/482,427

(22) Filed: Jul. 7, 2006

(30) Foreign Application Priority Data
Jul. 7, 2005 (JP) 2005-198414

(51) Int. Cl. B08B 7/00

(52) U.S. Cl. 134/6; 15/77; 15/88.2

(57) ABSTRACT

An inventive substrate cleaning brush includes a peripheral surface cleaning portion, and a marginal area cleaning portion connected to the peripheral surface cleaning portion. The peripheral surface cleaning portion has a peripheral surface cleaning surface to be pressed against a peripheral surface of a substrate. The marginal area cleaning portion has a marginal area cleaning surface to be pressed against a marginal area of a major surface of the substrate, and the marginal area cleaning surface projects from the peripheral surface cleaning surface by a variable projection length.

### BACKGROUND OF THE INVENTION

1. Field of the Invention

The present invention relates to a substrate cleaning brush, and a substrate treatment apparatus and a substrate treatment method using the substrate cleaning brush. Exemplary substrates to be treated with the use of the substrate cleaning brush include semiconductor wafers, substrates for liquid crystal display devices, substrates for plasma display devices, substrates for field emission display (FED) devices, optical disks and magnetic disks.

2. Description of Related Art

In general, a surface of a semiconductor substrate (wafer) is not entirely used for device formation. That is, a marginal area of the surface of the semiconductor substrate having a predetermined width is a device non-formation region in which no device is formed. A center area of the surface of the semiconductor substrate inward of the device non-formation region serves as a device formation region.

In a semiconductor device production process, a substrate treatment apparatus to be used for cleaning the semiconductor substrate principally performs a cleaning operation on the semiconductor substrate for cleaning the device formation region. For example, the cleaning of the device formation region is achieved by cleaning a major surface of the semiconductor substrate with a cleaning brush while rotating the substrate by a mechanical chuck with a peripheral surface of the substrate held by a plurality of holder pins of the chuck.

In this case, interference between the cleaning brush and the holder pins should be avoided. Therefore, the marginal area (device non-formation region) of the major surface of the substrate and the peripheral surface of the substrate (hereinafter collectively referred to as “marginal portion”) cannot be cleaned. The marginal portion of the substrate is brought into contact with hands of a substrate transport robot which handles the semiconductor substrate in the substrate treatment apparatus and with a substrate retention rack of a carrier (a cassette or the like) for retaining the substrate. Therefore, foreign matter is liable to adhere to the marginal portion.

Depending on a process to be performed on the substrate, contamination of the marginal portion of the substrate significantly influences the quality of the treatment of the semiconductor substrate. Specifically, a process performed by immersing the semiconductor substrate in a treatment liquid is the case. More specifically, a plurality of substrates arranged in juxtaposition in a vertical posture are immersed in a treatment liquid in a treatment liquid bath in a so-called batch process. In this state, the foreign matter adhering to the marginal portions of the substrates is liable to spread in the treatment liquid and adhere again to the device formation regions of the substrates.

Therefore, there is an increasing demand for the cleaning of the marginal portion of the substrate. Particularly, where the device formation region of the substrate is kept clean, it is desirable to selectively clean the marginal portion of the substrate to avoid an adverse influence on the device formation region.

### SUMMARY OF THE INVENTION

One conceivable approach to the cleaning of the marginal portion of the substrate is, for example, to press a cleaning brush against the marginal portion of the substrate while rotating the substrate.

However, the width of the device non-formation region (a range required to be cleaned) is not fixed, but varies (as having different known values) depending on a lot. Therefore, plural types of cleaning brushes should be prepared and selectively used for scrubbing only the device non-formation region and the peripheral surface without influencing the device formation region. This necessitates replacement of the cleaning brush, inevitably lowering the productivity.

Another conceivable approach is to utilize the elastic deformation characteristic of the cleaning brush to vary a brush pressing force for pressing the cleaning brush against the peripheral surface of the substrate depending on the lot to change a cleaning range. However, this means that a scrubbing strength is varied depending on the lot. Therefore, it is impossible to independently adjust the cleaning range of the marginal portion of the substrate and the scrubbing strength.

It is therefore an object of the present invention to provide a substrate cleaning brush which ensures that the cleaning range can be changed without the need for the replacement of the brush and the scrubbing strength can be easily adjusted, and a substrate treatment apparatus and a substrate treatment method which employ the substrate cleaning brush.

The inventive substrate cleaning brush includes a peripheral surface cleaning portion having a peripheral surface cleaning surface to be pressed against a peripheral surface of a substrate, and a marginal area cleaning portion connected to the peripheral surface cleaning portion and having a marginal area cleaning surface to be pressed against a marginal area of a major surface of the substrate, the marginal area cleaning surface projecting from the peripheral surface cleaning surface by a variable projection length.

With this arrangement, the marginal portion of the substrate can be cleaned with the use of the substrate cleaning brush having the marginal area cleaning surface which projects from the peripheral surface cleaning surface by the variable projection length. Since the cleaning range of the marginal area of the substrate is determined by the projection length of the marginal area cleaning surface, the size of the cleaning range can be variably set even with the use of the single substrate cleaning brush. Further, the cleaning range is changed by changing the projection length of the marginal area cleaning surface as measured from the peripheral surface cleaning surface, so that the brush pressing force for pressing the substrate cleaning brush against the substrate can be flexibly adjusted. Thus, the substrate can be properly cleaned by independently adjusting the pressing force and the cleaning range.

The marginal area cleaning portion may include a first portion having a first marginal area cleaning surface projecting from the peripheral surface cleaning surface by a first distance, and a second portion having a second marginal area cleaning surface projecting from the peripheral surface cleaning surface by a second distance that is different from the first distance. With this arrangement, the cleaning range can be set as corresponding to the first distance by pressing the first marginal area cleaning surface of the first portion against the marginal area of the substrate. Further, the cleaning range can be set as corresponding to the second distance by pressing the second marginal area cleaning surface of the second portion against the marginal area of the substrate. Therefore, the cleaning range of the marginal area of the substrate can be changed by properly selecting either the first portion or the second portion for cleaning the marginal area of the substrate. Thus, the cleaning range can be selectively set to plural ranges even with the use of the single substrate cleaning brush.

The marginal area cleaning surface of the marginal area cleaning portion may project from the peripheral surface cleaning surface by a projection length that is continuously varied along an edge of the peripheral surface cleaning surface. With this arrangement, the projection length of the marginal area cleaning surface is continuously varied along the edge of the peripheral surface cleaning surface. Thus, the cleaning range of the marginal area of the substrate can be variably set by properly selecting a portion of the peripheral surface cleaning surface to be pressed against the peripheral surface of the substrate. Therefore, the cleaning range can be selectively set to plural ranges even with the use of the single substrate cleaning brush.

The peripheral surface cleaning surface may be generally cylindrical. With this arrangement, the marginal portion of the substrate is cleaned by pressing the cylindrical peripheral surface cleaning surface against the peripheral surface of the substrate and pressing the marginal area cleaning surface projecting from the peripheral surface cleaning surface against the marginal area of the substrate. This makes it possible to press the substrate cleaning brush against the peripheral surface of the substrate with a uniform pressing force and at the same time, to easily change the cleaning range.

In this case, the marginal area cleaning surface may be circular and eccentric with respect to the peripheral surface cleaning surface. With this arrangement, the projection length of the marginal area cleaning surface as measured from the peripheral surface cleaning surface is continuously varied along the edge of the peripheral surface cleaning surface, because the marginal area cleaning surface is circular and eccentric with respect to the cylindrical peripheral surface cleaning surface. Thus, the cleaning range of the marginal area of the substrate can be varied depending on the portion of the peripheral surface cleaning surface to be pressed against the peripheral surface of the substrate. Therefore, the cleaning range can be selectively set to plural ranges even with the use of the single substrate cleaning brush.

The peripheral surface cleaning surface may be defined by a stepped cylindrical circumferential surface including a plurality of cylindrical surfaces having different diameters. With this arrangement, where the marginal area cleaning portion includes a plurality of disk-shaped flanges axially arranged and having the same diameter, for example, the disk-shaped flanges project from the corresponding cylindrical surfaces by different projection lengths. Thus, the cleaning range of the marginal area of the substrate can be varied depending on which of the cylindrical surfaces is pressed against the peripheral surface of the substrate. Therefore, the cleaning range can be selectively set to plural ranges even with the use of the single substrate cleaning brush.

The peripheral surface cleaning surface may be elliptically cylindrical. In this case, for example, the marginal area cleaning surface is preferably circular and coaxial with the peripheral surface cleaning surface. With this arrangement, the projection length of the marginal area cleaning surface (to be pressed against the marginal area of the substrate) as measured from the peripheral surface cleaning surface can be varied by changing the portion of the peripheral surface cleaning surface to be pressed against the peripheral surface of the substrate. Thus, the cleaning range of the marginal area of the substrate can be varied depending on the portion of the peripheral surface cleaning surface to be pressed against the peripheral surface of the substrate. Therefore, the cleaning range can be selectively set to plural ranges even with the use of the single substrate cleaning brush.

The marginal area cleaning portion preferably includes a first marginal area cleaning portion and a second marginal area cleaning portion which are simultaneously pressed against marginal areas of opposite major surfaces of the substrate. With this arrangement, the first marginal area cleaning portion and the second marginal area cleaning portion are simultaneously pressed against the marginal areas of the opposite major surfaces of the substrate to clean the marginal areas of the substrate. Thus, the marginal areas of the opposite major surfaces of the substrate can be simultaneously cleaned.

The inventive substrate treatment apparatus includes a substrate holding mechanism which holds a substrate, a substrate cleaning brush having the aforementioned features, a brush pressing mechanism which presses the substrate cleaning brush against the substrate held by the substrate holding mechanism, and a relative movement mechanism which moves the substrate held by the substrate holding mechanism and the substrate cleaning brush relative to each other along an peripheral surface of the substrate.

With this arrangement, the cleaning range of the marginal area of the substrate can be variably set to any of plural ranges having different sizes even with the use of the single substrate cleaning brush.

Where the substrate is a round substrate, the relative movement mechanism may be a substrate rotating mechanism which rotates the substrate. In this case, the substrate cleaning brush is pressed against the substrate being rotated, whereby the substrate and the substrate cleaning brush are moved relative to each other for the cleaning of the substrate. Where the substrate is a polygonal substrate, the relative movement mechanism may be a straight movement mechanism which moves the substrate and the substrate cleaning brush relative to each other linearly along an edge of the substrate. Thus, the substrate and the substrate cleaning brush are moved relative to each other for the cleaning of the substrate.

The inventive substrate treatment method includes the steps of pressing a substrate cleaning brush having the aforementioned features against a substrate, and moving the substrate and the substrate cleaning brush relative to each other along a peripheral surface of the substrate. According to the present invention, the cleaning range of the marginal area of the substrate can be variably set to any of plural ranges having different sizes even with the use of the single substrate cleaning brush.

The foregoing and other objects, features and effects of the present invention will become more apparent from the following detailed description of preferred embodiments with reference to the attached drawings.

### BRIEF DESCRIPTION OF THE DRAWINGS

FIG. 1 is a plan view schematically illustrating the construction of a major portion of a substrate treatment apparatus according to one embodiment of the present invention;

FIG. 2 is a block diagram illustrating an arrangement for controlling the substrate treatment apparatus;

FIG. 3 is a front view schematically illustrating a substrate cleaning brush in use as seen horizontally according to the embodiment of the present invention;

FIG. 4 is a plan view schematically illustrating the substrate cleaning brush in use as seen vertically according to the embodiment of the present invention;

FIG. 5 is a front view schematically illustrating a substrate cleaning brush in use as seen horizontally according to another embodiment of the present invention;

FIG. 6 is a front view illustrating the construction of a substrate cleaning brush according to further another embodiment of the present invention;

FIG. 7 is a front view illustrating the construction of a substrate cleaning brush according to still another embodiment of the present invention;

FIGS. 8(a) and 8(b) are a front view and a plan view, respectively, illustrating the construction of a substrate cleaning brush according to further another embodiment of the present invention;

FIGS. 9(a) and 9(b) are a front view and a plan view, respectively, illustrating the construction of a substrate cleaning brush according to still another embodiment of the present invention;

FIGS. 10(a) and 10(b) are a front view and a plan view, respectively, illustrating the construction of a substrate cleaning brush according to further another embodiment of the present invention;

FIGS. 11(a) and 11(b) are a front view and a plan view, respectively, illustrating the construction of a substrate cleaning brush according to still another embodiment of the present invention;

FIGS. 12(a) and 12(b) are a front view and a plan view, respectively, illustrating the construction of a substrate cleaning brush according to further another embodiment of the present invention; and

FIGS. 13(a) and 13(b) are a front view and a plan view, respectively, illustrating the construction of a substrate cleaning brush according to still another embodiment of the present invention.

### DETAILED DESCRIPTION OF PREFERRED EMBODIMENTS

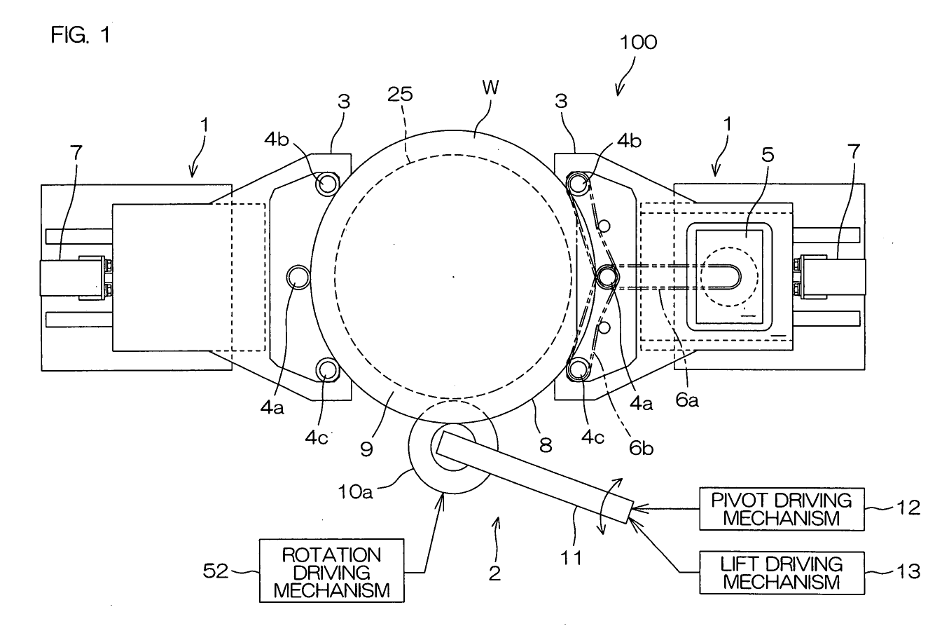

FIG. 1 is a plan view schematically illustrating the construction of a major portion of a substrate treatment apparatus according to one embodiment of the present invention. The substrate treatment apparatus 100 is of a single substrate treatment type, which is adapted to treat generally round substrates W (e.g., semiconductor wafers) on a one-by-one basis. The substrate treatment apparatus 100 includes a substrate holding/rotating mechanism 1 (serving as a substrate holding mechanism and a relative movement mechanism) which holds and rotates a substrate W, and a substrate cleaning mechanism 2 which scrubs the substrate W.

The substrate holding/rotating mechanism 1 has a pair of holder hands 3 disposed in opposed relation. The holder hands 3 each have three holder rollers 4a, 4b, 4c provided upright for holding the substrate W. The holder rollers 4a, 4b, 4c are arranged circularly in association with a peripheral surface of the substrate W. The substrate W is held horizontally with its peripheral surface 8 in abutment against side surfaces of the holder rollers 4a, 4b, 4c.

A driving force of a holder roller driving motor 5 is transmitted to a middle one 4a of the three holder rollers 4a, 4b, 4c via a belt 6a. The driving force applied to the middle holder roller 4a is transmitted to the holder rollers 4b, 4c via a belt 6b. When the middle holder roller 4a is driven by the holder roller driving motor 5, the other two holder rollers 4b, 4c are correspondingly rotated. As a result, the substrate W held by the holder rollers 4a, 4b, 4c is rotated.

The holder hands 3 each include a cylinder 7 (advancement/retraction driving mechanism) for horizontally advancing and retracting the holder hands 3 to move the holder hands 3 toward and away from each other. Thus, the holder hands 3 are capable of holding the substrate W between the holder rollers 4a, 4b, 4c thereof and releasing the substrate W from the holder rollers 4a, 4b, 4c thereof.

The substrate cleaning mechanism 2 includes a sponge-like substrate cleaning brush 10a for scrubbing the peripheral surface 8 and a marginal area 9 of the substrate W, a pivot arm 11 holding the substrate cleaning brush 10a downward at its distal end, a pivot driving mechanism 12 (brush pressing mechanism) which pivots the pivot arm 11 about a vertical axis defined outside a substrate rotation range to horizontally press the substrate cleaning brush 10a against the substrate W, a lift driving mechanism 13 (brush pressing mechanism) which vertically moves the pivot arm 11 to press the substrate cleaning brush 10a vertically against the substrate W, and a rotation driving mechanism 52 which rotates the substrate cleaning brush 10a about a vertical axis.

With this arrangement, the peripheral surface 8 and the marginal area 9 of the substrate W are cleaned by pressing the substrate cleaning brush 10a against the peripheral surface 8 and the marginal area 9 of the substrate W while rotating the substrate W held by the substrate holding/rotating mechanism 52.

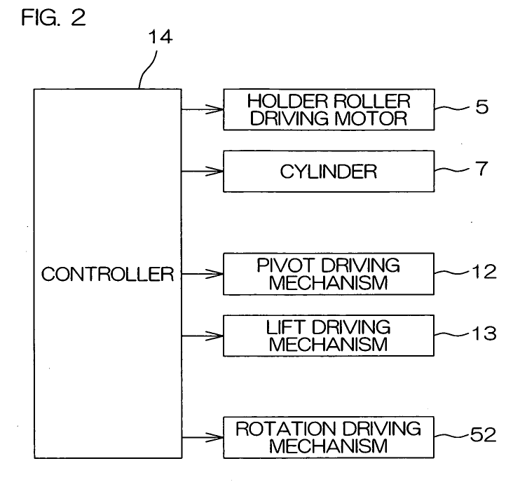

FIG. 2 is a block diagram illustrating an arrangement for controlling the substrate treatment apparatus. The substrate treatment apparatus 100 includes a controller 14. The controller 14 controls operations of the holder roller driving motor 5 and the cylinder 7 of the substrate holding/rotating mechanism 1. The controller 14 also controls operations of the pivot driving mechanism 12, the lift driving mechanism 13 and the rotation driving mechanism 52 of the substrate cleaning mechanism 2.

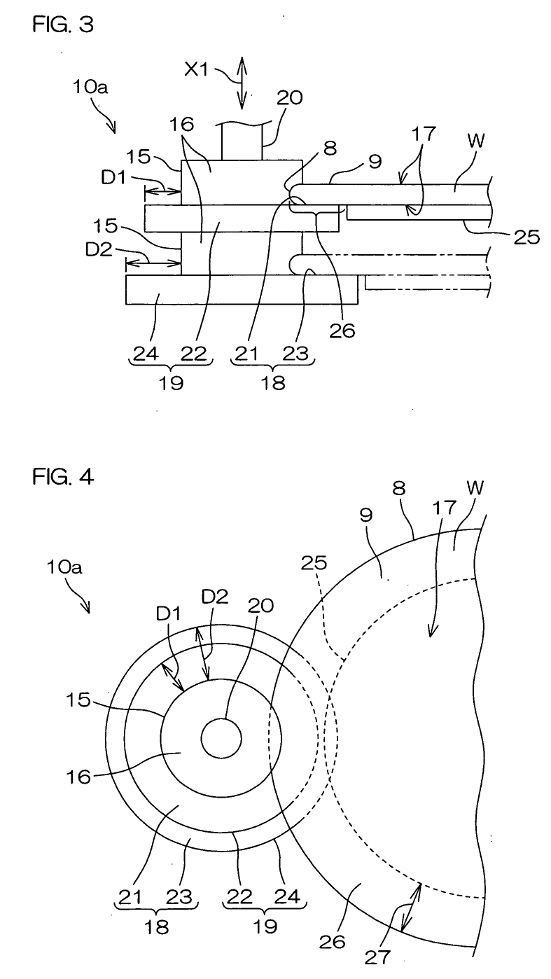

FIG. 3 is a front view schematically illustrating the construction of the substrate cleaning brush in use as seen horizontally according to the embodiment of the present invention. FIG. 4 is a plan view schematically illustrating the construction of the substrate cleaning brush in use as seen vertically according to the embodiment of the present invention.

The substrate cleaning brush 10a is composed of a sponge material such as of PVA (polyvinyl alcohol) The substrate cleaning brush 10a includes a cylindrical peripheral surface cleaning portion 16 having a peripheral surface cleaning surface 15 to be pressed against the peripheral surface 8 of the substrate W for cleaning the peripheral surface 8 of the substrate W, and a marginal area cleaning portion 19 connected unitarily to the peripheral surface cleaning portion 16 and having marginal area cleaning surfaces 18 to be pressed against the marginal area 9 of one major surface 17 of the substrate W. The marginal area cleaning surfaces 18 each project a predetermined distance from the peripheral surface cleaning surface 15. The marginal area 9 of the substrate W is cleaned by one of the marginal area cleaning surfaces 18.

The peripheral surface cleaning portion 16 is cylindrical, and a shaft 20 is attached to one end of the peripheral surface cleaning portion 16. The substrate cleaning brush 10a is held downward by the pivot arm 11 via the shaft 20. A driving force of the rotation driving mechanism 52 is transmitted to the substrate cleaning brush 10a via the shaft 20, where by the substrate cleaning brush 10a is rotated about the vertical axis of the shaft 20 defined as a rotation axis. The substrate cleaning brush 10a is pressed against the substrate W in a non-rotation state when a marginal portion (the marginal area 9 and the peripheral surface 8) of the substrate W is cleaned.

The marginal area cleaning portion 19 includes a first portion 22 and a second portion 24 which are each provided as a disk-shaped flange. The first portion 22 and the second portion 24 are spaced from each other axially of the peripheral surface cleaning portion 16 (in an axial direction X1). The first portion 22 has a first marginal area cleaning surface 21 which projects a first distance D1 from the peripheral surface cleaning surface 15. The second portion 24 has a second marginal area cleaning surface 23 which projects a second distance D2 (that is different from the first distance D1) from the peripheral surface cleaning surface 15.

The first portion 22 is generally coaxially connected to the peripheral surface cleaning portion 16 so as to separate upper and lower portions of the peripheral surface cleaning surface 15 from each other in the axial direction X1. The second portion 24 is generally coaxially connected to an end face of the peripheral surface cleaning portion 16 opposite from the one end to which the shaft 20 is attached.

When the substrate W is cleaned, the controller 14 causes the substrate holding/rotating mechanism 1 shown in FIG. 1 to hold and rotate the substrate W. Then, the controller 14 causes the pivot driving mechanism 12 and the lift driving mechanism 13 to press the substrate cleaning brush 10a against the substrate W being rotated. Thus, the marginal portion of the substrate W is cleaned. At this time, the controller 14 controls the rotation driving mechanism 52 to keep the substrate cleaning brush 10a still at a predetermined rotation angular position.

More specifically, as shown in FIGS. 2 and 3, the substrate W is held and rotated by the substrate holding/rotating mechanism 1 with the major surface 17 (device formation surface formed with a device (semiconductor device) 25) facing down. In this state, the peripheral surface cleaning surface 15 of the substrate cleaning brush 10a is pressed against the peripheral surface 8 of the substrate W with a predetermined pressing force. Further, the first marginal area cleaning surface 21 or the second marginal area cleaning surface 23 is pressed against the marginal area 9 of the lower surface (device formation surface) of the substrate W with a predetermined pressing force. Thus, a brush pressing step is performed for pressing the substrate cleaning brush 10a against the substrate W, and in this state a relatively moving step is performed for moving the substrate cleaning brush 10a along the peripheral surface 8 of the substrate W, whereby the peripheral surface 8 and the marginal area 9 of the substrate W are cleaned.

The marginal area 9 of the substrate W to be cleaned by the first marginal area cleaning surface 21 or the second marginal area cleaning surface 23 is a device non-formation region 26 in which no device 25 is formed. A device formation region is defined in a center region inward of the device non-formation region 26. The width 27 of the device non-formation region 26 (a range required to be cleaned) is not fixed, but varies as having different known values depending on a lot.

As described above, the substrate cleaning brush 10a has the first marginal area cleaning surface 21 projecting the first distance D1 from the peripheral surface cleaning surface 15 and the second marginal area cleaning surface 23 projecting the second distance D2 (different from the first distance D1) from the peripheral surface cleaning surface 15. Therefore, the cleaning range can be set to one of two ranges defined by the first and second distances D1, D2 by selectively using the first marginal area cleaning surface 21 and the second marginal area cleaning surface 23. Thus, the cleaning range of the substrate marginal area 9 can be variably set.

Therefore, plural types of substrates W with device non-formation regions 26 having different widths 27 can be cleaned with the single substrate cleaning brush 10a by selectively using the first marginal area cleaning surface 21 and the second marginal area cleaning surface 23.

According to this embodiment, as described above, the cleaning range can be selectively set to the plural ranges by selectively using the first marginal area cleaning surface 21 and the second marginal area cleaning surface 23 which have different projection lengths as measured from the peripheral surface cleaning surface 15. Thus, the marginal portions of the plural types of substrates W with the device non-formation regions 26 having different widths 27 can be cleaned with the use of the single substrate cleaning brush 10a. This eliminates the need for changing the substrate cleaning brush 10a for every lot, and improves the productivity.

Since the cleaning range is variably set by changing the projection length of the marginal area cleaning surface 18, the brush pressing force for pressing the substrate cleaning brush 10a against the substrate W (pressing forces for pressing the peripheral surface cleaning surface 15 and the marginal area cleaning surfaces 21, 23 against the substrate W) can be flexibly adjusted. Thus, the scrubbing strength can be adjusted independently of the cleaning range to properly clean the substrate W.

Further, the service life of the substrate cleaning brush 10a can be prolonged by rotating the substrate cleaning brush 10a. That is, the substrate cleaning brush 10a which has a rotationally symmetrical shape is rotated about the shaft 20 as a rotation axis by a predetermined angle by the rotation driving mechanism 52. This prevents the substrate cleaning brush 10a from being partly worn heavily in contact with the marginal portion of the substrate W, thereby prolonging the service life of the substrate cleaning brush 10a. The substrate cleaning brush 10a is rotated, for example, when the lot is changed or during a period after the completion of the cleaning of one substrate W before the start of the cleaning of the next substrate W in the substrate treatment apparatus 100. The substrate cleaning brush 10a is preferably rotated when the brush does not abut against the substrate W.

FIG. 5 is a front view schematically illustrating the construction of a substrate cleaning brush in use as seen horizontally according to another embodiment of the present invention. In FIG. 5, components equivalent to those shown in FIG. 3 will be denoted by the same reference characters as in FIG. 3. Further, reference will be made again to FIGS. 1 and 2.

A major difference between the substrate cleaning brush 10b shown in FIG. 5 and the substrate cleaning brush 10a shown in FIG. 3 is that the peripheral surface cleaning portion 16 has a cylindrical shape extending below the second portion 24 and a cylindrical peripheral surface cleaning surface 30 is present below the second portion 24. The peripheral surface cleaning surface 30 present below the second portion 24 has a length that is not smaller than the thickness 28 of the substrate W as measured in the axial direction X1.

In this embodiment, the substrate W is horizontally held by the substrate holding/rotating mechanism 1 with the device formation surface thereof (the major surface thereof formed with the device 25) facing up. In this state, the peripheral surface 8 and the marginal area 9 of the substrate W are scrubbed with the substrate cleaning brush 10b.

In the scrubbing, positional relation between the substrate W and the substrate cleaning brush 10b is controlled such that the substrate W is located between the first portion 22 and the second portion 24 of the substrate cleaning brush 10b or below the second portion 24 of the substrate cleaning brush 10b. In practice, such positional relation is achieved by controlling the position of the substrate cleaning brush 10b.

More specifically, a lower surface of the first portion 22 serves as the first marginal area cleaning surface 21, and a lower surface of the second portion 24 serves as the second marginal area cleaning surface 23. Further, a part of the peripheral surface cleaning surface 15 present between the first and second portions 22, 24 serves as the first peripheral surface cleaning surface 29 to be used in combination with the first marginal area cleaning surface 21, and a part of the peripheral surface cleaning surface 15 present below the second portion 24 serves as the second peripheral surface cleaning surface 30 to be used in combination with the second marginal area cleaning surface. 23.

Where the device non-formation region of the substrate W has a relatively small width, the first portion 22 is used. In this case, the marginal area 9 of the upper surface of the substrate W is pressed against the first marginal area cleaning surface 21, and the peripheral surface 8 of the substrate W is pressed against the first peripheral surface cleaning surface 29.

On the other hand, where the device non-formation region of the substrate W has a relatively great width, the second portion 24 is used. In this case, the marginal area 9 of the upper surface of the substrate W is pressed against the second marginal area cleaning surface 23, and the peripheral surface 8 of the substrate W is pressed against the second peripheral surface cleaning surface 30.

In this embodiment, the first and second marginal area cleaning surfaces 21, 23 are thus selectively used, whereby marginal areas 9 of plural types of substrates W with device non-formation regions having different widths can be properly cleaned.

In the substrate cleaning brush 10b of FIG. 5, the peripheral surface cleaning surface 15 further includes a third peripheral surface cleaning surface 31 provided above the first portion 22. Therefore, the substrate cleaning brush 10b of FIG. 5 can also be used when the substrate W is horizontally held with its device formation surface facing down. Where there is no need to treat the substrate W with the device formation surface facing down, the third peripheral surface cleaning surface 31 is not required.

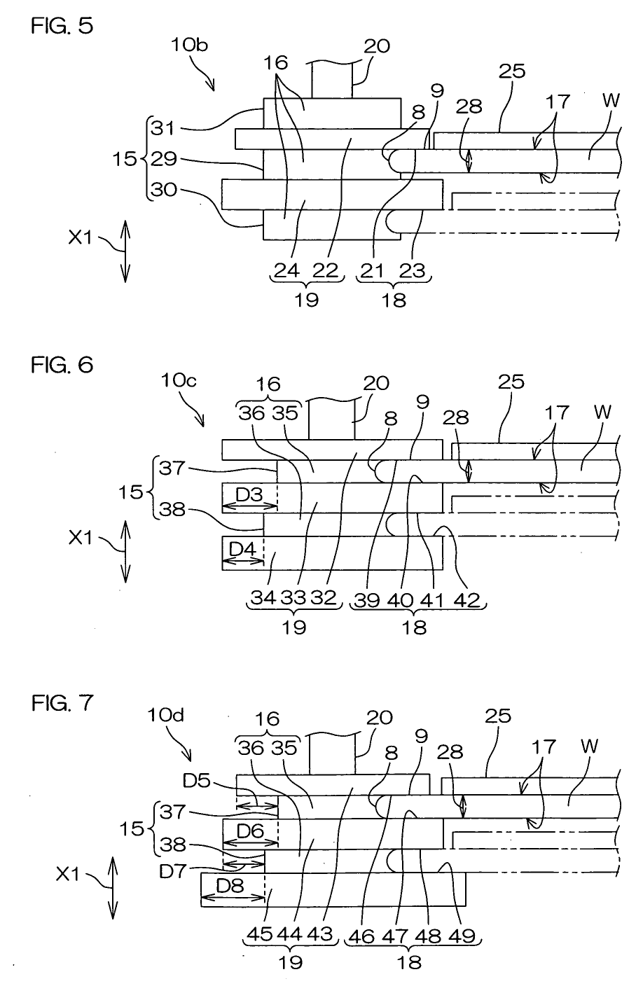

FIG. 6 is a front view illustrating the construction of a substrate cleaning brush according to further another embodiment of the present invention. In FIG. 6, components equivalent to those shown in FIG. 3 will be denoted by the same reference characters as in FIG. 3. Further, reference will be made again to FIGS. 1 and 2.

The substrate cleaning brush 10c according to this embodiment is configured such that the marginal areas 9 of the opposite major surfaces 17 of the substrate W can be simultaneously cleaned. More specifically, the substrate cleaning brush 10c includes a peripheral surface cleaning portion 16, and a first marginal area cleaning portion 32, a second marginal area cleaning portion 33 and a third marginal area cleaning portion 34 which are spaced from one another in the axial direction X1 and unitarily connected to the peripheral surface cleaning portion 16.

The peripheral surface cleaning portion 16 has a stepped cylindrical shape, and includes an upper smaller diameter portion 35 and a lower greater diameter portion 36. The smaller diameter portion 35 and the greater diameter portion 36 each have a cylindrical peripheral surface. The cylindrical peripheral surfaces of the smaller diameter portion 35 and the greater diameter portion 36 respectively serve as a fourth peripheral surface cleaning surface 37 and a fifth peripheral surface cleaning surface 38 for cleaning the peripheral surface 8 of the substrate W. The first to third marginal area cleaning portions 32, 33, 34 are provided as disk-shaped flanges disposed coaxially with the peripheral surface cleaning portion 16 and having the same diameter, and each have a marginal area cleaning surface 18 projecting perpendicularly to the axial direction X1 of the peripheral surface cleaning portion 16. The smaller diameter portion 35 is located between the first and second marginal area cleaning portions 32, 33, and the greater diameter portion 36 is located between the second and third marginal area cleaning portions 33, 34.

A lower surface of the first marginal area cleaning portion 32 and an upper surface of the second marginal area cleaning portion 33 respectively serve as a third marginal area cleaning surface 39 and a fourth marginal area cleaning surface 40 which are opposed to and spaced from each other by a distance corresponding to the length of the smaller diameter portion 35 of the peripheral surface cleaning portion 16. The length of the smaller diameter portion 35 of the peripheral surface cleaning portion 16 as measured in the axial direction X1 is slightly smaller than the thickness 28 of the substrate W.

A lower surface of the second marginal area cleaning portion 33 and an upper surface of the third marginal area cleaning portion 34 respectively serve as a fifth marginal area cleaning surface 41 and a sixth marginal area cleaning surface 42 which are opposed to and spaced from each other by a distance corresponding to the length of the greater diameter portion 36 of the peripheral surface cleaning portion 16. The length of the greater diameter portion 36 of the peripheral surface cleaning portion 16 as measured in the axial direction X1 is slightly smaller than the thickness 28 of the substrate W.

The third marginal area cleaning surface 39 and the fourth marginal area cleaning surface 40 present on opposite sides of the smaller diameter portion 35 project from the fourth peripheral surface cleaning surface 37 by a distance D3, and the fifth marginal area cleaning surface 41 and the sixth marginal area cleaning surface 42 present on opposite sides of the greater diameter portion 36 project from the fifth peripheral surface cleaning surface 38 by a distance D4 (D3>D4). A difference between the distances D3 and D4 is equal to a difference in radius between the smaller diameter portion 35 and the greater diameter portion 36.

When the peripheral surface 8 and the marginal areas 9 of the substrate W are to be scrubbed, the fourth peripheral surface cleaning surface 37 or the fifth peripheral surface cleaning surface 38 is pressed against the peripheral surface 8 of the substrate W. Thus, the peripheral surface 8 of the substrate W and the marginal areas 9 of the opposite major surfaces 17 of the substrate W are simultaneously scrubbed. Which of the smaller diameter portion 35 and the greater diameter portion 36 of the peripheral surface cleaning portion 16 is to be used for the cleaning of the peripheral surface is determined depending on the width of the device non-formation region of the substrate W to be cleaned.

FIG. 7 is a front view illustrating the construction of a substrate cleaning brush according to still another embodiment of the present invention. In FIG. 7, components equivalent to those shown in FIG. 3 will be denoted by the same reference characters as in FIG. 3. Further, reference will be made again to FIGS. 1 and 2.

A major difference between the substrate cleaning brush 10d shown in FIG. 7 and the substrate cleaning brush 10c shown in FIG. 6 is that the marginal area cleaning portion 19 includes three disk-shaped flanges having different outer diameters.

The substrate cleaning brush 10d according to this embodiment is configured such that the marginal areas 9 of the opposite major surfaces 17 of the substrate W can be simultaneously cleaned and the cleaning ranges on the opposite major surfaces 17 of the substrate W can be set as having different sizes. More specifically, the substrate cleaning brush 10d includes a peripheral surface cleaning portion 16, and a fourth marginal area cleaning portion 43, a fifth marginal area cleaning portion 44 and a sixth marginal area cleaning portion 45 spaced from one another in the axial direction X1 and unitarily connected to the peripheral surface cleaning portion 16.

The fourth to sixth marginal area cleaning portions 43, 44, 45 are provided as disk-shaped flanges disposed coaxially with the peripheral surface cleaning portion 16 and having different outer diameters, and each have a marginal area cleaning surface 18 projecting perpendicularly to the axial direction X1 of the peripheral surface cleaning portion 16. The peripheral surface cleaning portion 16 includes a smaller diameter portion 35 located between the fourth and fifth marginal area cleaning portions 43, 44 and a greater diameter portion 36 located between the fifth and sixth marginal area cleaning portions 44, 45.

A lower surface of the fourth marginal area cleaning portion 43 and an upper surface of the fifth marginal area cleaning portion 44 respectively serve as a seventh marginal area cleaning surface 46 and an eighth marginal area cleaning surface 47 which are opposed to and spaced from each other by a distance corresponding to the length of the smaller diameter portion 35 of the peripheral surface cleaning portion 16. A lower surface of the fifth marginal area cleaning portion 44 and an upper surface of the sixth marginal area cleaning portion 45 respectively serve as a ninth marginal area cleaning surface 48 and a tenth marginal area cleaning surface 49 which are opposed to and spaced from each other by a distance corresponding to the length of the greater diameter portion 36.

The seventh marginal area cleaning surface 46 present on the lower surface of the fourth marginal area cleaning portion 43 projects from the fourth peripheral surface cleaning surface 37 by a distance D5, and the eighth marginal area cleaning surface 47 present on the upper surface of the fifth marginal area cleaning portion 44 projects from the fourth peripheral surface cleaning surface 37 by a distance D6 (D6>D5) Further, the ninth marginal area cleaning surface 48 present on the lower surface of the fifth marginal area cleaning portion 44 projects from the fifth peripheral surface cleaning surface 38 by a distance D7 (D6>D7), and the tenth marginal area cleaning surface 49 present on the upper surface of the sixth marginal area cleaning portion 45 projects from the fifth peripheral surface cleaning surface 38 by a distance D8 (D8>D7).

When the peripheral surface 8 and the marginal areas 9 of the substrate W are to be scrubbed, the smaller diameter portion 35 or the greater diameter portion 36 of the peripheral surface cleaning portion 16 is pressed against the peripheral surface 8 of the substrate W. Where the smaller diameter portion 35 is pressed against the peripheral surface 8 of the substrate W, the seventh marginal area cleaning surface 46 and the eighth marginal area cleaning surface 47 are respectively pressed against the marginal areas 9 of the upper and lower surfaces of the substrate W at the same time.

On the other hand, where the greater diameter portion 36 is pressed against the peripheral surface 8 of the substrate W, the ninth marginal area cleaning surface 48 and the tenth marginal area cleaning surface 49 are respectively pressed against the marginal areas 9 of the upper and lower surfaces of the substrate W at the same time.

Thus, the substrate cleaning brush 10d can simultaneously clean the marginal areas 9 of the opposite major surfaces 17 of the substrate W, and the cleaning ranges on the opposite major surfaces 17 of the substrate W can be set as having different sizes.

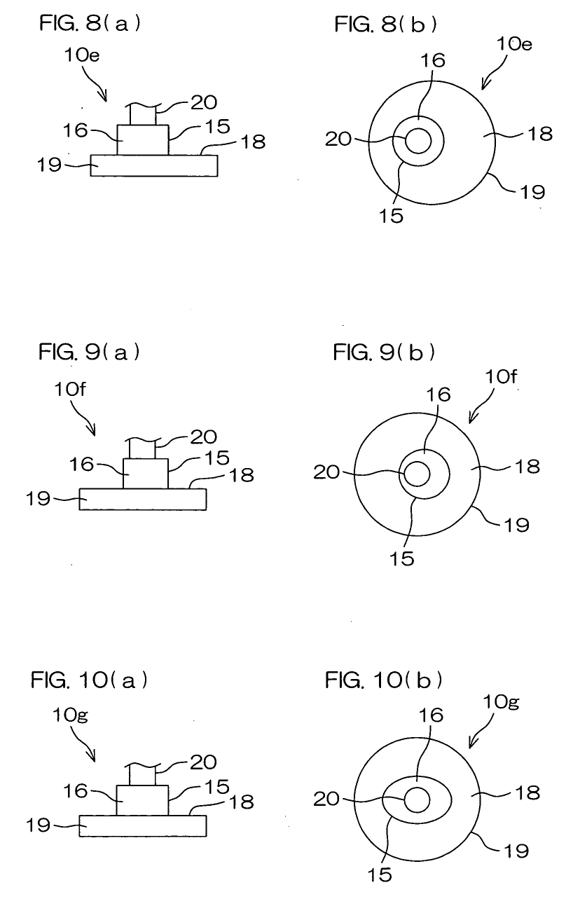

FIGS. 8(a) and 8(b) are a front view and a plan view, respectively, illustrating the construction of a substrate cleaning brush according to further another embodiment of the present invention. In FIGS. 8(a) and 8(b), components equivalent to those shown in FIG. 3 will be denoted by the same reference characters as in FIG. 3. Further, reference will be made again to FIGS. 1 and 2.

The substrate cleaning brush 10e according to this embodiment includes a shaft 20, a cylindrical peripheral surface cleaning portion 16 and a marginal area cleaning portion 19 of a disk-shaped flange. The shaft 20 and the peripheral surface cleaning portion 16 are coaxially connected to each other, and the marginal area cleaning portion 19 is connected to one end of the peripheral surface cleaning portion 16 eccentrically with respect to the shaft 20 and the peripheral surface cleaning portion 16. Thus, the projection length of a marginal area cleaning surface 18 of the marginal area cleaning portion 19 as measured from a peripheral surface cleaning surface 15 of the peripheral surface cleaning portion 16 is continuously varied along an edge of the peripheral surface cleaning surface 15. Therefore, the rotation angular position of the substrate cleaning brush 10e is changed by controlling the rotation driving mechanism 52 by the controller 14, whereby the cleaning range of the marginal area 9 of the substrate W can be variably set. Since the shaft 20 defined as the rotation shaft of the substrate cleaning brush 10e and the peripheral surface cleaning portion 16 are coaxial with each other, a pressing force to be applied to the peripheral surface 8 of the substrate W can be kept substantially constant irrespective of the rotation angular position of the substrate cleaning brush 10e.

FIGS. 9(a) and 9(b) are a front view and a plan view, respectively, illustrating the construction of a substrate cleaning brush according to still another embodiment of the present invention. In FIGS. 9(a) and 9(b), components equivalent to those shown in FIG. 3 will be denoted by the same reference characters as in FIG. 3. Further, reference will be made again to FIGS. 1 and 2.

The substrate cleaning brush 10f according to this embodiment includes a shaft 20, a cylindrical peripheral surface cleaning portion 16, and a marginal area cleaning portion 19 of a disk-shaped flange. The shaft 20 and the marginal area cleaning portion 19 are coaxially connected to each other, and the peripheral surface cleaning portion 16 is connected to one end of the marginal area cleaning portion 19 eccentrically with respect to the shaft 20 and the marginal area cleaning portion 19. Thus, the projection length of a marginal area cleaning surface 18 of the marginal area cleaning portion 19 as measured from a peripheral surface cleaning surface 15 of the peripheral surface cleaning portion 16 is continuously varied along an edge of the peripheral surface cleaning surface 15. Therefore, a portion of the peripheral surface cleaning surface 15 to be pressed against the peripheral surface 8 of the substrate W is changed by rotating the shaft 20 defined as the rotation shaft by the rotation driving mechanism 52, whereby the cleaning range can be variably set to any of plural ranges.

FIGS. 10(a) and 10(b) are a front view and a plan view, respectively, illustrating the construction of a substrate cleaning brush according to further another embodiment of the present invention. In FIGS. 10(a) and 10(b), components equivalent to those shown in FIG. 3 will be denoted by the same reference characters as in FIG. 3. Further, reference will be made again to FIGS. 1 and 2.

The substrate cleaning brush 10g according to this embodiment includes a shaft 20, a peripheral surface cleaning portion 16 having an elliptically cylindrical peripheral surface cleaning surface 15, and a marginal area cleaning portion 19 of a disk-shaped flange. The shaft 20, the peripheral surface cleaning portion 16 and the marginal area cleaning portion 19 are coaxially connected to one another. Thus, the projection length of a marginal area cleaning surface 18 of the marginal area cleaning portion 19 as measured from the peripheral surface cleaning surface 15 is continuously varied along an edge of the peripheral surface cleaning surface 15. Therefore, a portion of the peripheral surface cleaning surface 15 to be pressed against the peripheral surface 8 of the substrate W is changed by rotating the shaft 20 defined as the rotation shaft by the rotation driving mechanism 52, whereby the cleaning range can be variably set to any of plural ranges.

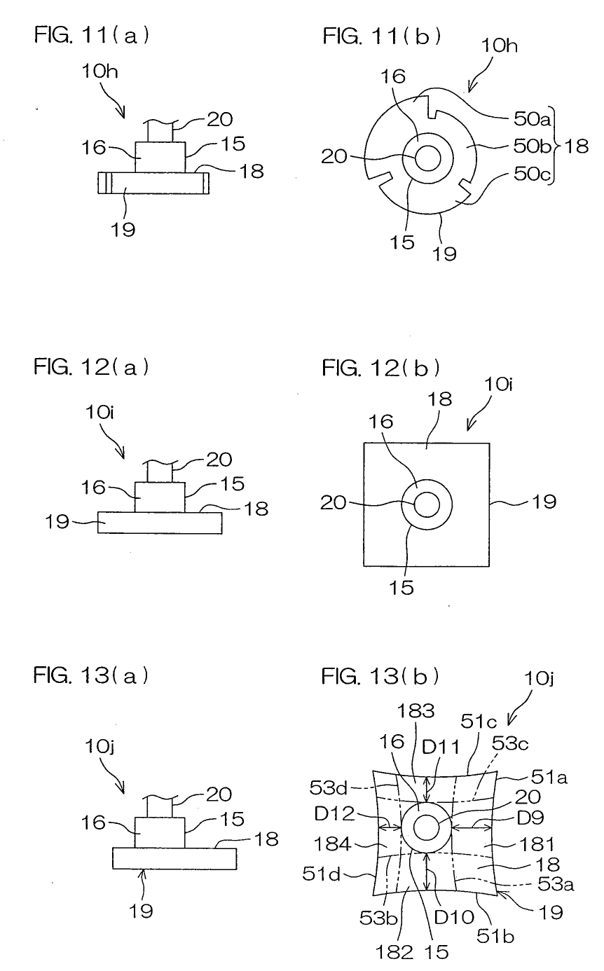

FIGS. 11(a) and 11(b) are a front view and a plan view, respectively, illustrating the construction of a substrate cleaning brush according to still another embodiment of the present invention. In FIGS. 11(a) and 11(b), components equivalent to those shown in FIG. 3 will be denoted by the same reference characters as in FIG. 3. Further, reference will be made again to FIGS. 1 and 2.

The substrate cleaning brush 10h according to this embodiment includes a shaft 20, a cylindrical peripheral surface cleaning portion 16, and a marginal area cleaning portion 19 having a plurality of fan-shaped marginal area cleaning surfaces (in this embodiment, three fan-shaped marginal area cleaning surfaces 50a, 50b, 50c) having different outer diameters. The shaft 20, the peripheral surface cleaning portion 16 and the marginal area cleaning portion 19 are coaxially connected to one another. The fan-shaped marginal area cleaning surfaces 50a, 50b, 50c have the same center, and are disposed in circumferentially offset relation. Thus, the fan-shaped marginal area cleaning surfaces 50a, 50b, 50c have different projection lengths as measured from the peripheral surface cleaning surface 15. Therefore, the fan-shaped marginal area cleaning surfaces 50a, 50b, 50c are selectively used for the cleaning of the marginal area 9 of the substrate W by rotating the substrate cleaning brush 10h by the rotation driving mechanism 52, whereby the cleaning range of the marginal area 9 of the substrate W can be varied.

FIGS. 12(a) and 12(b) are a front view and a plan view, respectively, illustrating the construction of a substrate cleaning brush according to further another embodiment of the present invention. In FIGS. 12(a) and 12(b), components equivalent to those shown in FIG. 3 will be denoted by the same reference characters as in FIG. 3. Further, reference will be made again to FIGS. 1 and 2.

The substrate cleaning brush 10i according to this embodiment includes a shaft 20, a cylindrical peripheral surface cleaning portion 16, and a marginal area cleaning portion 19 having a rectangular marginal area cleaning surface 18. The shaft 20, the peripheral surface cleaning portion 16 and the marginal area cleaning portion 19 are coaxially connected to one another. Thus, the projection length of the marginal area cleaning surface 18 as measured from a peripheral surface cleaning surface 15 of the peripheral surface cleaning portion 16 is continuously varied along an edge of the peripheral surface cleaning surface 15. Therefore, the cleaning range can be variably set to any of plural ranges by changing a portion of the peripheral surface cleaning surface 15 to be pressed against the peripheral surface 8 of the substrate W.

FIGS. 13(a) and 13(b) are a front view and a plan view, respectively, illustrating the construction of a substrate cleaning brush according to still another embodiment of the present invention. In FIGS. 13(a) and 13(b), components equivalent to those shown in FIG. 3 will be denoted by the same reference characters as in FIG. 3. Further, reference will be made again to FIGS. 1 and 2.

The substrate cleaning brush 10j according to this embodiment includes a shaft 20, a cylindrical peripheral surface cleaning portion 16 coaxially connected to the shaft 20, and a generally rectangular marginal area cleaning portion 19 connected to the peripheral surface cleaning portion 16. The peripheral surface cleaning portion 16 has a cylindrical peripheral surface cleaning surface 15.

The contour of the marginal area cleaning portion 19 as seen in plan is defined by four arcs 51a, 51b, 51c, 51d concaved toward the shaft 20. Distances D9, D10, D11, D12 between the arcs 51a, 51b, 51c, 51d and the peripheral surface cleaning surface 15 are different from each other, and satisfy a relationship of D9>D10>D11>D12.

A surface of the marginal area cleaning portion 19 adjacent to the peripheral surface cleaning portion 15 serves as a marginal area cleaning surface 18 to be pressed against the marginal area 9 of the substrate W. The marginal area cleaning surface 18 has four marginal area cleaning regions 181, 182, 183, 184 in association with the four arcs 51a, 51b, 51c, 51d. The marginal area cleaning region 181 is an elongated region defined by the arc 51a and another arc 53a contacting the peripheral surface cleaning surface 15. The arc 53a is an arc which is inwardly concaved toward the peripheral surface cleaning surface 15 and has the same curvature center as the arc 51a and the same curvature radius as the substrate W. Similarly, the marginal area cleaning regions 182, 183, 184 are elongated regions each defined by the arc 51b, 51c, 51d and another arc 53b, 53c, 53d contacting the peripheral surface cleaning surface 15. The arc 53b, 53c, 53d is an arc which is inwardly concaved toward the peripheral surface cleaning surface 15 and has the same curvature center as the arc 51b, 51c, 51d and the same curvature radius as the substrate W.

When the substrate cleaning brush 10j is used, the controller 14 controls the rotation driving mechanism 52 to control the rotation angular position of the substrate cleaning brush 10j so that one of the arcs 51a to 51d is opposed to the rotation center of the substrate W. Thus, a corresponding one of the elongated marginal area cleaning regions 181, 182, 183, 184 is pressed against the marginal area 9 of the substrate W. The projection lengths of the marginal area cleaning regions 181, 182, 183 and 184 as measured from the peripheral surface cleaning surface 15 are equal to distances D9, D10, D11 and D12, respectively. Therefore, the cleaning range of the marginal area 9 can be variably set to any of four ranges.

By properly selecting one of the marginal area cleaning regions 181, 182, 183, 184, a corresponding one of the arcs 51a, 51b, 51c, 51d fits along the peripheral edge of the device formation region defined in the major surface of the substrate W. Thus, the marginal area 9 of the substrate W can be efficiently cleaned.

While the embodiments of the present invention have thus been described, the invention may be embodied in any other ways. For example, the peripheral surface cleaning portion and the marginal area cleaning portion of the substrate cleaning brush are not necessarily required to be integrally formed, but may be provided as separate members which are unitarily connected to each other.

The embodiments described above are directed to the treatment of the round substrate, but the present invention is applicable to a polygonal substrate to provide the same effects as described above. In this case, a straight movement mechanism may be employed for linearly moving the substrate cleaning brush and the substrate relative to each other. More specifically, the substrate cleaning brush is pressed against a substrate held by a substrate holding mechanism and fixed, and the substrate holding mechanism is moved by the straight movement mechanism to linearly move the substrate relative to the substrate cleaning brush. Alternatively, the substrate is fixed, and the substrate cleaning brush is moved by the straight movement mechanism to linearly move the substrate cleaning brush relative to the substrate. Further, both the substrate and the substrate cleaning brush may be moved relative to each other by the straight movement mechanism for linear relative movement of the substrate and the substrate cleaning brush.

While the present invention has been described in detail by way of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2005-198414 filed in the Japanese Patent Office on Jul. 7, 2005, the disclosure of which is incorporated herein by reference.

What is claimed is:

1. A substrate cleaning brush comprising:
a peripheral surface cleaning portion having a peripheral surface cleaning surface to be pressed against a peripheral surface of a substrate; and
a marginal area cleaning portion connected to the peripheral surface cleaning portion and having a marginal area cleaning surface to be pressed against a marginal area of a major surface of the substrate, the marginal area cleaning surface projecting from the peripheral surface cleaning surface by a variable projection length.

2. A substrate cleaning brush as set forth in claim 1, wherein the marginal area cleaning portion includes:
a first portion having a first marginal area cleaning surface projecting from the peripheral surface cleaning surface by a first distance; and
a second portion having a second marginal area cleaning surface projecting from the peripheral surface cleaning surface by a second distance that is different from the first distance.

3. A substrate cleaning brush as set forth in claim 1, wherein the projection length of the marginal area cleaning surface of the marginal area cleaning portion as measured from the peripheral surface cleaning surface is continuously varied along an edge of the peripheral surface cleaning surface.

4. A substrate cleaning brush as set forth in claim 1, wherein the peripheral surface cleaning surface is generally cylindrical.

5. A substrate cleaning brush as set forth in claim 4, wherein the marginal area cleaning surface is circular and eccentric with respect to the peripheral surface cleaning surface.

6. A substrate cleaning brush as set forth in claim 1, wherein the peripheral surface cleaning surface is defined by a stepped cylindrical circumferential surface including a plurality of cylindrical surfaces having different diameters.

7. A substrate cleaning brush as set forth in claim 1, wherein the peripheral surface cleaning surface is elliptically cylindrical.

8. A substrate cleaning brush as set forth in claim 7, wherein the marginal area cleaning surface is circular and coaxial with a center of the peripheral surface cleaning surface.

9. A substrate cleaning brush as set forth in claim 1, wherein the marginal area cleaning portion includes a first marginal area cleaning portion and a second marginal area cleaning portion which are simultaneously pressed against marginal areas of opposite major surfaces of the substrate.

10. A substrate treatment apparatus comprising:
a substrate holding mechanism which holds a substrate;
a substrate cleaning brush as recited in claim 1;
a brush pressing mechanism which presses the substrate cleaning brush against the substrate held by the substrate holding mechanism; and
a relative movement mechanism which moves the substrate held by the substrate holding mechanism and the substrate cleaning brush relative to each other along an peripheral surface of the substrate.

11. A substrate treatment method comprising the steps of:
pressing a substrate cleaning brush as recited in claim 1 against a substrate; and
moving the substrate and the substrate cleaning brush relative to each other along a peripheral surface of the substrate.
